(19) United States
(12) Patent Application Publication
(10) Pub. No.: US 2019/0050623 A1
(43) Pub. Date: Feb. 14, 2019

(54) ELECTRICAL VALIDATION OF A PURPORTED FINGER

(71) Applicant: ZWIPE AS, Oslo (NO)

(72) Inventors: Jose Ignacio Wintergerst LAVIN, Colorado Springs, CO (US); Jorgen FRANDSEN, Broomfield, CO (US)

(21) Appl. No.: 16/086,710

(22) PCT Filed: May 8, 2017
(86) PCT No.: PCT/EP2017/060960

§ 371 Date: Sep. 20, 2018

Related U.S. Application Data
(60) Provisional application No. 62/332,535, filed on May 6, 2016.

(30) Foreign Application Priority Data
Jun. 3, 2016 (GB) 1609768.5

(51) Int. Cl. G06K 9/00

(52) U.S. Cl. CPC G06K 9/0012; G06K 9/0002

(57) ABSTRACT

A fingerprint authorisable smartcard 102 comprises an active capacitance fingerprint sensor 130 and an array of electrodes 34, 36, 38 positioned on a bezel 30 surrounding a scan area of the fingerprint sensor 130. The smartcard 102 is configured to supply a driving voltage signal for the fingerprint sensor 130 via driving electrodes 38, and to supply a plurality of time-varying property measurement voltage signals via emitting electrodes 34. The smartcard 102 is further configured to detect the property measurement voltage signals, via respective detection electrodes 36, after transmission through the finger. The smartcard 102 verifies the identity of the bearer of the finger using the fingerprint sensor 102, and validates physical properties of the finger using the detected property measurement voltage signals.

The present invention relates to a fingerprint authorisable device including means for validation of a purported finger presented to the device.

Fingerprint authorised devices such as fingerprint authorised smartcards are becoming increasingly more widely used. Smartcards for which fingerprint authorisation has been proposed include, for example, access cards, credit cards, debit cards, pre-pay cards, loyalty cards, identity cards, cryptographic cards, and so on. Other devices are also known that make use of fingerprint authorisation, and these include computer memory devices, building access control devices, military technologies, vehicles and so on.

In fingerprint identification it is important to be able to distinguish a true, live finger from a fake finger. Fake fingers can have a variety of compositions. For example, a false finger could be a silicone replica of a real finger, a fingerprint patch glued to a real finger, or it could be a dead finger removed from a real person.

Detection of a fake finger may involve software algorithms to detect unique image characteristics. Detection can also involve electrical characteristics. The present invention relates to electrical detection.

The present invention provides a fingerprint authentication device comprising: an active capacitance fingerprint sensor (e.g. comprising an array of active capacitance fingerprint sensor electrodes) and an array of (second) electrodes positioned adjacent the fingerprint sensor such that a finger presented to the sensor covers at least two of the electrodes, wherein the device is configured to supply a driving voltage signal for the fingerprint sensor via one or more of the electrodes, to supply one or more a property measurement voltage signal(s) via one or more of the electrodes, and to detect the one or more property measurement voltage signal(s) via one or more of the electrodes, after transmission through the finger; and wherein the device is configured to verify the identity of the bearer of the finger based on a fingerprint detected by the fingerprint sensor, and to validate at least one physical property of the finger based on the detected property measurement voltage signal(s).

An active capacitance fingerprint sensor uses a driving voltage to apply a charge to the skin before measurement takes place. The driving voltage signal provides a periodically varying signal that alternates between charge and discharge cycles and a fingerprint is detected by measuring how the voltage is discharged from the surface of the finger using an array of active capacitance fingerprint sensor electrodes arranged across a sensor area of the fingerprint sensor. When using an active capacitance fingerprint sensor conventionally, one or more driving electrodes are positioned around the fingerprint sensor to provide this driving voltage to a finger presented to the sensor. In accordance with the above arrangement, an array of electrodes adjacent the sensor area is positioned adjacent the sensor area and configured to not only supply the driving voltage, but to also detect one or more property measurement signals in order to validate the finger, i.e. to determine whether one or more properties of the finger fall within expected ranges for a genuine finger. This arrangement thus ensures that the finger being presented to the device not only matches the authorised bearer, but is also a genuine and/or live finger.

In one embodiment, the driving signal for the fingerprint sensor may serve as (one of) the property measurement signal(s). Thus, the same voltage signal may both drive the fingerprint scan as well as allowing the device to measure the one or more properties of the purported finger. Alternatively, and more preferably, the driving voltage signal may be different from the one or more a property measurement signal(s). For example, the property detection voltage signals may be at a different frequency to the driving voltage signal or may have a different waveform shape. Preferably, the device is also configured to supply the driving voltage signal and the one or more a property measurement voltage signal(s) via different electrodes.

Whilst the described embodiments herein relate to an active capacitance fingerprint sensor, it will be appreciated that this configuration may be alternative applied more broadly to any biometric sensor requiring a driving voltage signal. In yet further embodiments, the array of second electrodes may be arranged to detect the validity of a finger presented to any other biometric sensor, such as a fingerprint sensor other than an active capacitance fingerprint sensor, as well as alternative non-fingerprint biometric sensors such as those employing EKG sensors or the like.

The property measurement voltage signal is preferably a periodically varying voltage signal. For example, the property measurement voltage signals may be sinusoidal waveforms or other repeating waveform. In some embodiments, the property measurement voltage signal may be an amplitude or frequency modulated signal. In some embodiments, one of the property measurement voltage signals may comprise a swept voltage signal. In yet further embodiments one of the property measurement voltage signals may be a DC voltage signal.

In some embodiments, the property measurement voltage signal(s) may comprise a single voltage signal having two or more different frequency components, preferably of substantially equal magnitude. This single voltage signal may be supplied via a single one of the electrodes, or more than one electrode may supply the same signal.

Alternatively, the device may be configured to apply a first property measurement voltage signal to a first one of the electrodes and a second, different voltage signal across a different second one of the electrodes. In preferred embodiments, the plurality of electrodes may comprise a plurality of electrode pairs, wherein the device is configured to apply a different voltage signal across each pair of electrodes. For example, frequency filters (either physical or digital) may be used so that each detection electrode detects only certain property measurement voltage signals, and preferably only one property measurement voltage signal.

In some embodiments, however, one electrode may appear in two pairs of electrodes. For example, one electrode may be used as to transmit to two different electrodes, each receiving a different signal (e.g. using filters), or one electrode may receive different signals from two different electrodes. However, preferably each electrode appears in no more than one pair of electrodes.

The arrangement whereby multiple property detection signals are applied to the finger may have applications for validation of a purported finger outside of the field of active capacitance fingerprint sensors. Thus, in an alternative aspect, the present invention may also be seen to provide a fingerprint authentication device comprising: a fingerprint sensor and an array of electrode pairs positioned adjacent the fingerprint sensor such that a finger presented to the sensor covers at least two pairs of the electrodes, wherein the device is configured to supply at least two different property measurement voltage signals, each across a different electrode pair, and to detect each of the property measurement voltage signals after transmission through the finger; and wherein the device is configured to validate the physical properties of a finger presented to the device based on the detected property measurement voltage signals. Such a device may include any one or more or all of the optional features of the first aspect. The fingerprint sensor in this alternative aspect is optionally not an active capacitance fingerprint sensor.

The array of (second) electrodes is preferably configured in the form of a plurality of conductive electrode members electrically isolated from one another by insulator. In one embodiment, the array of electrodes may be formed as a ball grid array. A ball grid array comprises a plurality of conductive electrode pads formed on or recessed into an insulating surface, such that each of the conductive electrode pads is electrically insulated from each adjacent conductive electrode pad. In an alternative arrangement, the array of electrodes may be configured as alternating conductive regions separated by insulating regions in a rubber or elastomer matrix (known commonly as Zebra Connections®).

Ball grid arrays and Zebra Connections® are well known for use as terminals on surface mounted electronics. However, these connections have not previously been employed on an outward facing surface of a device to provide voltage signals to a finger presented to a fingerprint sensor. The use of these known connections in this manner allows for the array of electrodes to be manufactured in a cost effective manner by employing well-known manufacturing techniques.

Indeed, such an arrangement may have applications for validation of a purported finger outside of the field of active capacitance fingerprint sensors. Thus, in an alternative aspect, the present invention may also be seen to provide a fingerprint authentication device comprising: a fingerprint sensor and an array of electrodes positioned adjacent the fingerprint sensor such that a finger presented to the sensor covers at least two of the electrodes, wherein the array of electrodes are configured as a ball grid array or as alternating conductive regions separated by insulating regions in a rubber or elastomer matrix, wherein the device is configured to supply one or more a property measurement voltage signal(s) via one or more of the electrodes, and to detect the one or more property measurement voltage signal(s) via one or more of the electrodes, after transmission through the finger; and wherein the device is configured to validate the at least one physical property of a finger presented to the device based on the detected property measurement voltage signal(s). Such a device may include any one or more or all of the optional features of the first aspect. The fingerprint sensor in this alternative aspect is optionally not an active capacitance fingerprint sensor.

It will be appreciated that various electrode configurations are possible. However, the electrodes are preferably configured to surround the scan area, i.e. the area defined by the array first of electrodes. For example, the first array preferably defines a fingerprint sensor area, and the array of second electrodes is preferably outside of the fingerprint sensor area. In the case of a rectangular fingerprint sensor area, for example, a ball grid array may be arranged in a rectangular line (e.g. one or two or more balls thick) surrounding and adjacent the scan area. Alternatively the plurality of electrodes may be provided by four zebra connections may be arranged adjacent the scan area to form a rectangular line surrounding the scan area.

The fingerprint authentication device may comprise a control system that may include a fingerprint processor for executing a fingerprint matching algorithm and a memory for storing enrolled fingerprint data. The control system of the device may include multiple processors, and the fingerprint processor may be a separate processor associated with the fingerprint sensor. Other processors may include a control processor for controlling basic functions of the device, such as communication with other devices (e.g. via contactless technologies), activation and control of receivers/transmitters, activation and control of secure elements such as for financial transactions and so on. The various processors could be embodied in separate hardware elements, or could be combined into a single hardware element, but with separate software modules.

The device may be configured to validate the at least one physical property of the finger by comparing either the detected property measurement voltage signal(s) or a value derived therefrom with a stored value. The stored values preferably comprise threshold values for valid finger, e.g. for a live finger and/or a genuine finger. That is to say a valid finger would be expected to meet the threshold and an invalid finger (e.g. a fake finger or a non-live finger) would not be expected to meet the threshold. The device is preferably configured not to authorise the bearer of the fingerprint if the physical properties do not meet the threshold values.

The fingerprint authentication preferably also includes a memory storing the stored values. The memory may be the same or separate to the memory storing the enrolled fingerprint. The stored values are preferably permanent stored on the memory, but in some embodiments may be modifiable.

In some embodiment, physical properties of the finger may include electrical properties, such as an electrical impedance of the finger or a resistance of the finger or a capacitance of the finger. Electrical properties of the finger are most preferably measured as these can be determined to a high degree of accuracy. However, other physical properties that can be approximated by application of an electrical signal include the density of the finger or a pulse rate in the finger. It should be understood that the term “physical property of the finger” is not intended to include the fingerprint of the finger, i.e. the validation of the finger is separate from the verification of its fingerprint.

The fingerprint authentication device may be capable of wireless communication, such as using RFID or NFC communication. Alternatively or additionally the device may comprise a contact connection, for example via a contact pad or the like such as those used for “chip and pin” payment cards. In various embodiments, the device may permit both wireless communication and contact communication.

The device may be configured to perform an action, such as transmitting a signal indicating authentication of the bearer of the device, only when the finger is validated and the identity of a bearer of the finger has been verified. For example, the device may be configured to provide access to one or more functions of the device in response to identification of a valid and authorised finger.

The fingerprint authentication device may be a portable device, by which is meant a device designed for being carried by a person, preferably a device small and light enough to be carried conveniently. The device can be arranged to be carried within a pocket, handbag or purse, for example. The fingerprint authentication device may, for example, be a smartcard such as a fingerprint authorisable RFID card. The device may be any one of an access card, a credit card, a debit card, a pre-pay card, a loyalty card, an identity card, a cryptographic card, or the like. The fingerprint authentication device may alternatively be a control token for controlling access to a system external to the control token, such as a one-time-password device for access to a computer system or a fob for a vehicle keyless entry system. The fingerprint authentication device is preferably also portable in the sense that it does not rely on a wired power source. The device may be powered by an internal battery and/or by power harvested contactlessly from a reader or the like, for example from an RFID reader.

The fingerprint authentication device may be a single-purpose device, i.e. a device for interacting with a single external system or network or for interacting with a single type of external system or network, wherein the device does not have any other purpose. Such a device is to be distinguished from complex and multi-function devices such as smartphones, tablet computers and the like.

Where the fingerprint authentication device is a smartcard, it preferably has a width of between 85.47 mm and 85.72 mm, and a height of between 53.92 mm and 54.03 mm. The smartcard may have a thickness less than 0.84 mm, and preferably of about 0.76 mm (e.g. ±0.08 mm). More generally, the smartcard may comply with ISO 7816, which is the specification for a smartcard.

Where the device is a control token it may for example be a keyless entry key for a vehicle, in which case the external system may be the locking/access system of the vehicle and/or the ignition system. The external system may more broadly be a control system of the vehicle. The control token may act as a master key or smart key, with the radio frequency signal giving access to the vehicle features only being transmitted in response to identification of an authorised user. Alternatively the control token may act as a remote locking type key, with the signal for unlocking the vehicle only being able to be sent if the fingerprint authorisation module identifies an authorised user. In this case the identification of the authorised user may have the same effect as pressing the unlock button on prior art keyless entry type devices, and the signal for unlocking the vehicle may be sent automatically upon fingerprint or non-fingerprint identification of an authorised user, or sent in response to a button press when the control token has been activated by authentication of an authorised user.

In various embodiments, the fingerprint authentication device may include a two part enclosure for holding the fingerprint sensor. The two part enclosure may comprising an inner casing for attachment to a circuit board of the fingerprint authentication device and for enclosing the fingerprint sensor and an outer bezel for retaining the fingerprint sensor within the inner casing, wherein the outer bezel is arranged to be coupled to the inner casing. In such a configuration, the plurality of electrodes may be formed on the outer bezel.

The inner casing and the outer bezel can act as a reinforcement member for protection of the fingerprint sensor. The use of a two part enclosure ensures that the fingerprint sensor can be protected from torsion/bending forces when the fingerprint authentication device is in use and is bent or twisted. By having an inner casing and outer bezel that couple together the manufacture of the fingerprint sensor assembly is straightforward in terms of both of the electrical or the mechanical connections, and the fingerprint sensor can easily be secured in place with minimal risk of damage to the fingerprint sensor.

The outer bezel may enclose some or all of the outer periphery of the fingerprint sensor and may include a side wall topped by a lip that extends over the top of an outer rim of a sensing surface of the fingerprint sensor. In example embodiments the bezel of the fingerprint sensor assembly extends around the entire outer periphery of the fingerprint sensor. The bezel is preferably formed from an insulator, and the plurality of electrodes may be electrically connected to the device. The bezel may hence be formed from an insulating plastic or ceramic material, or from insulator-coated metal or other conductive material.

Advantageously the circuit board may be a flexible printed circuit board. This allows the device to be flexible, for example to meet requirements such as ISO 7816 relating to smartcards. The inner casing may be mechanically attached to the circuit board and also electrically attached, advantageously using the same attachment mechanism for both the mechanical and the electrical attachment, for example by using surface mount technology, solder or conductive adhesive. The fingerprint sensor may be mechanically attached to the circuit board via the inner casing and also electrically attached to the circuit board directly or via the inner casing, advantageously the same attachment mechanism can be used for both the mechanical and the electrical attachment, for example by using surface mount technology, solder or conductive adhesive. The outer bezel may be mechanically attached to the inner casing and also electrically attached, advantageously using the same attachment mechanism for both the mechanical and the electrical attachment, for example by using surface mount technology, solder or conductive adhesive.

The inner casing and/or the outer bezel of the two part enclosure may have a shape corresponding to the shape of the fingerprint sensor. Thus, in the common example of a rectangular fingerprint sensor the inner casing and/or the outer bezel may have a rectangular shape. It is preferred for the inner casing and the outer bezel to have a similar shape and to be arranged for complementary fit with one another. For example, the outer bezel may be the same shape as the inner casing, but slightly larger so as to fit around the outside of the inner casing.

The inner casing may have side walls that extend away from the surface of the circuit board and at least partially enclose the fingerprint sensor. The side walls may extend away from the surface of the circuit board a sufficient distance so that the top of the fingerprint sensor is not exposed above the side walls. Preferably there is an opening in the side wall of the inner casing for allowing electrical connections between the circuit board and the fingerprint sensor. In the example of a rectangular inner casing the casing may have side walls about three sides of the rectangle with the fourth side of the rectangle having no side wall, or only a partial side wall. The inner casing may alternatively or additionally include conductive elements for making an electrical connection to the circuit board. This may be for connections to the fingerprint sensor and/or for an electrical connection to the electrodes of the outer bezel.

The outer bezel may enclose some or all of the outer periphery of the inner casing and preferably includes a side wall topped by a lip that extends across an outer rim of the exposed surface of the fingerprint sensor. The lip of the outer bezel may directly contact a sensing surface of the fingerprint sensor. Alternatively, in the case where a protective layer is present as discussed further below, the lip of the outer bezel may sit in contact with and/or above the protective layer, with the protective layer in between the lip and the sensing surface of the fingerprint sensor. The outer bezel may have a side wall extending from the lip toward the circuit board. An inner surface of the side wall of the outer bezel preferably fits in close proximity to an outer surface of the side wall of the inner casing. Advantageously, the side wall of the outer bezel may extend across the opening in the side wall of the inner casing, thereby ensuring that the fingerprint sensor is enclosed on all sides. The outer bezel can be fitted after any required electrical connections are made through the opening in the side wall of the inner casing. In example implementations the bezel has a side wall and/or lip that extends continuously around the entire periphery of the fingerprint sensor and/or protective layer.

The outer bezel may be arranged to be coupled to the inner casing via any suitable connection. The connection may be via an interference fit and/or through inter-coupling of resilient elements. For example, the connection may involve lugs on one of the two parts arranged to be received in recesses of the other of the two parts, where one or both parts is arranged to deform elastically during assembly to thereby provide a “snap-fit”. Other types of snap-fit connection may be used. The connection may alternatively or additionally use surface mount technology, solder and/or conductive adhesives.

Advantageously, the fingerprint sensor assembly may further include a protective layer located on top of a sensing surface of the fingerprint sensor, the protective layer comprising a scratch resistant material. The two part enclosure may act to enclose and retain the protective layer in the same way as it encloses and retains the fingerprint sensor, and hence may also be used to hold the protective layer in place on the sensing surface of the fingerprint sensor. The use of a two part enclosure in combination with a protective layer ensures that the fingerprint sensor can be protected from damage to its surface as well as protected from torsion/bending forces when the fingerprint authentication device is in use and is bent or twisted. By having an inner casing and outer bezel that couple together the manufacture of the fingerprint sensor assembly is straightforward, and the protective layer can easily be secured in place with minimal risk of damage to the fingerprint sensor.

The use of an added protective layer in the fingerprint sensor assembly provides significant advantages in terms of prolonging the lifespan of the fingerprint sensor and protecting it from damage. Fingerprint sensors are normally manufactured with a hard and scratch resistant surface coating for this purpose. However, the current inventor has made the realisation that this surface is still susceptible to damage, especially in the case where the fingerprint authentication device may be used frequently, such as in the example of a smartcard that could be used many times each day. Consequently, it is highly advantageous to include an additional protective layer, which is in addition to or potentially a substitute for the normal protective coatings of the fingerprint sensor.

It is important for the sensing surface of the fingerprint sensor to be protected against electrostatic discharge as well as scratches, impact, and every-day wear and tear. No matter where a fingerprint sensor is deployed, the sensor will undergo wear and tear as users place their fingers on the device for identification of an authorised fingerprint. As a consequence, fingerprint sensors can have shortened life spans due to the fact that a user must make physical contact in order for the device to successfully capture a fingerprint or the like to provide identification verification. In many situations users of the fingerprint authentication device may be prone to having dirty, greasy, or grimy fingers due to their job responsibilities or due to their daily activities. This can be in context of a specific role, such as within a factory where fingerprint authentication devices are used, or it may be from day-to-day activities such as handling foods. Whilst it can be recommended that such users clean their hands (or at least their enrolled digit) before attempting to authenticate, this advice will not always be followed. Dirty residue, oils or other materials on the surface of a fingerprint sensor can obscure the fingerprint image causing performance degradation in terms of false acceptance and false reject rates. Furthermore, a user might prefer to keep the fingerprint authentication device clean and again whilst they might be advised not to use certain products it is possible that this advice would be ignored leading to the use of cleaning solvents (especially those that are alcohol- or ammonia-based) that may damage the sensing surface of the fingerprint sensor. The repeated use of such products will lead to the sensor's protective layer becoming damaged. Such damage will result in decreased capture sensitivity, and will negatively impact the sensor's performance. The addition of a further protective layer as described above will reduce or completely avoid these problems.

In some examples the fingerprint sensor is a pre-existing product, i.e. “off-the-shelf” and the protective layer is added on top of the existing surface of the fingerprint sensor. In alternative implementations the fingerprint sensor may comprise a modified fingerprint sensor assembly in which an additional protective layer is incorporated at the top of the fingerprint sensor above the sensing surface either in addition to pre-existing coatings that might be applied, or as a substitute for such coatings. Thus, it will be understood that the protective layer may be separate to the fingerprint sensor or it could be incorporated as an integral part of the finger print sensor. The protective layer is however always an added material of significant thickness, for example at least 200 μm and possibly at least 300 μm, with protective properties going beyond those of protective coatings that are conventionally used with fingerprint sensors. In some cases the protective layer may have a comparable thickness to the underlying fingerprint sensor component

Preferably the protective layer has a thickness of 500 μm or less, for example a thickness of about 400 μm or less. This means that the addition of the protective layer does not generate any significant disadvantage in relation to the overall thickness of the fingerprint sensor assembly, and the fingerprint device may hence be a device where the thickness of the sensor assembly is significant, for example an electronic card such as a smartcard as discussed below.

The protective layer can be made of any suitable scratch resistant material that is compatible with the fingerprint sensor. Thus, the protective layer may for example have suitable dielectric properties for operation with a passive or active capacitance fingerprint sensor. The protective layer may have a hardness sufficient to provide a Vickers hardness test rating of at least 500, preferably at least 600. A ceramic material may be used. Ceramics can provide the required hardness and scratch resistance in combination with a suitable dielectric properties. In some examples the protective layer is a glass material, such as a chemically toughened glass as discussed below.

The protective layer may comprise chemically toughened glass. A graded zirconia glass may be used. One possible material is alkali-aluminosilicate sheet glass, such as the glass sold under the trade name Gorilla Glass® and manufactured by Corning Inc. of New York, USA. This type of glass is commonly used as a cover glass for touch screens on mobile devices such as smartphones and other similar cover glass products could be used for the protective layer. Thus, the protective layer may be made of a glass suitable for and/or prepared for use as cover glass for mobile devices. These types of glass have the required scratch resistance and other properties to allow for suitably thin layers and they also are compatible with fingerprint sensors such as sensors based on capacitive effects, hence allowing unimpeded operation of the fingerprint sensors whilst also protecting the more sensitive surface of the sensor from possible damage due to contaminants on the user's finger and/or the use of cleaning materials or cleaning products that could harm the sensor surface.

The protective layer may have an outer surface that is oleophobic. This allows the protective layer to resist damage arising from fingerprint oil as well as other contaminants that may be transferred to fingerprint sensor assemblies from the user's finger or otherwise during use of the fingerprint authentication device. The required oleophobic properties can be provided by the use of cover glass products designed for mobile devices as described above. Alternatively or additionally an oleophobic coating may be included at the outer surface of the protective layer.

The sensing surface of the fingerprint sensor may be a flat area directed outward from the device allowing easy access for the user's finger or thumb to be placed on the sensing surface. The protective layer is on top of the sensing surface and may cover all of the exposed area of the sensing surface in order to prevent direct contact of the user's finger or any other object or material with the sensing surface. The protective layer has an inner surface adjacent the sensing surface and an outer surface directed outward from the device. The protective layer is advantageously of uniform thickness and hence the outer surface of the protective layer may be parallel with the sensing surface of the fingerprint sensor. The protective layer may be about the same size as the sensing surface of the fingerprint sensor. Typical fingerprint sensors have a rectangular surface and the protective layer may also have a rectangular shape.

Certain preferred embodiments on the present invention will now be described in greater detail, by way of example only and with reference to the accompanying drawings, in which:

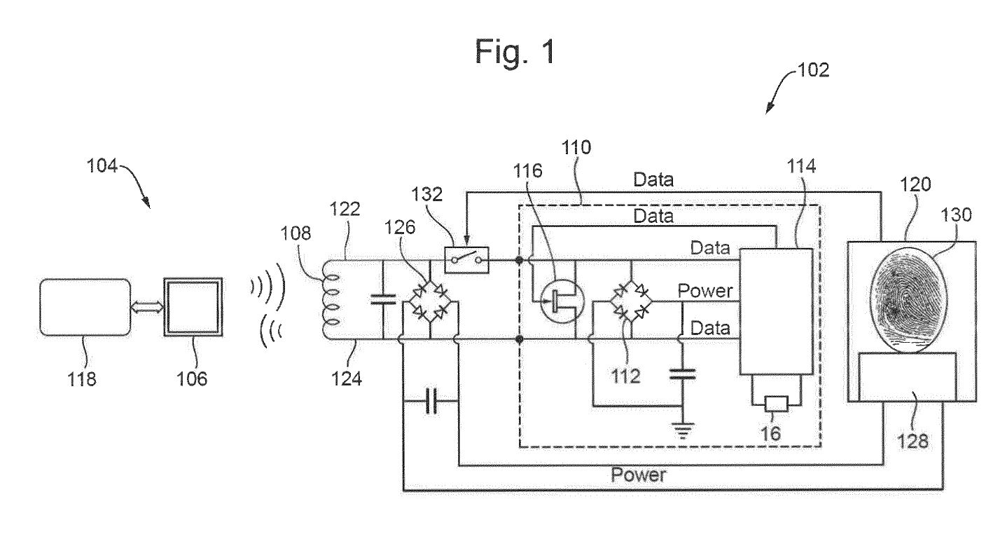

FIG. 1 illustrates a circuit for a smartcard with a fingerprint sensor;

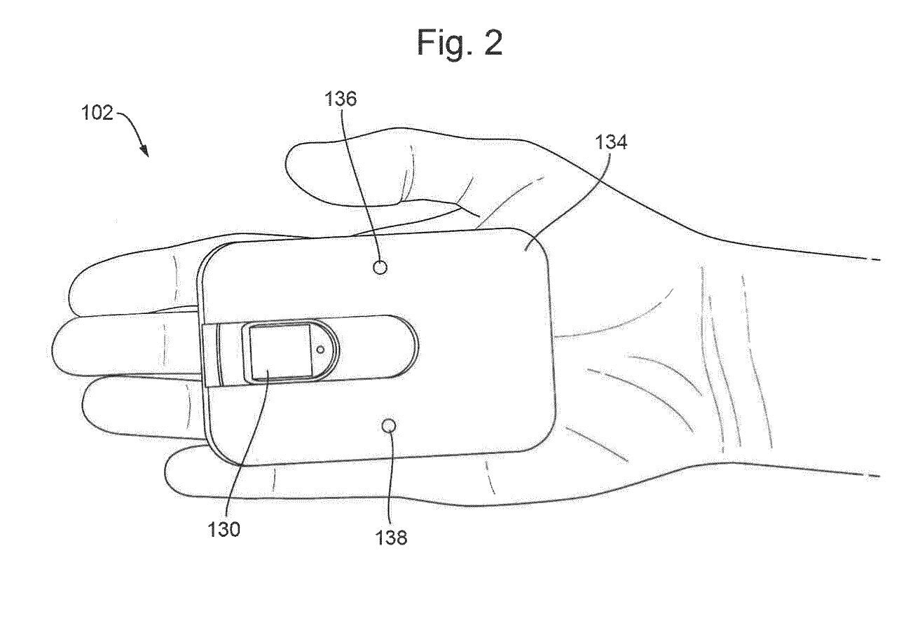

FIG. 2 illustrates a first example of the smartcard including an external housing;

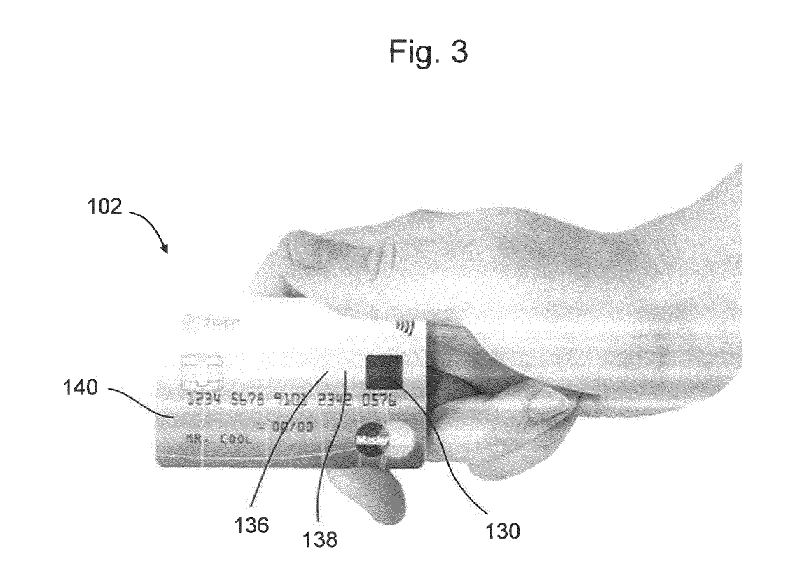

FIG. 3 illustrates a second example of the smartcard which has been laminated;

FIG. 4 shows a schematic plan view of an inner casing of a fingerprint sensor assembly;

FIG. 5 shows the inner casing of FIG. 4 in side/cross-section view;

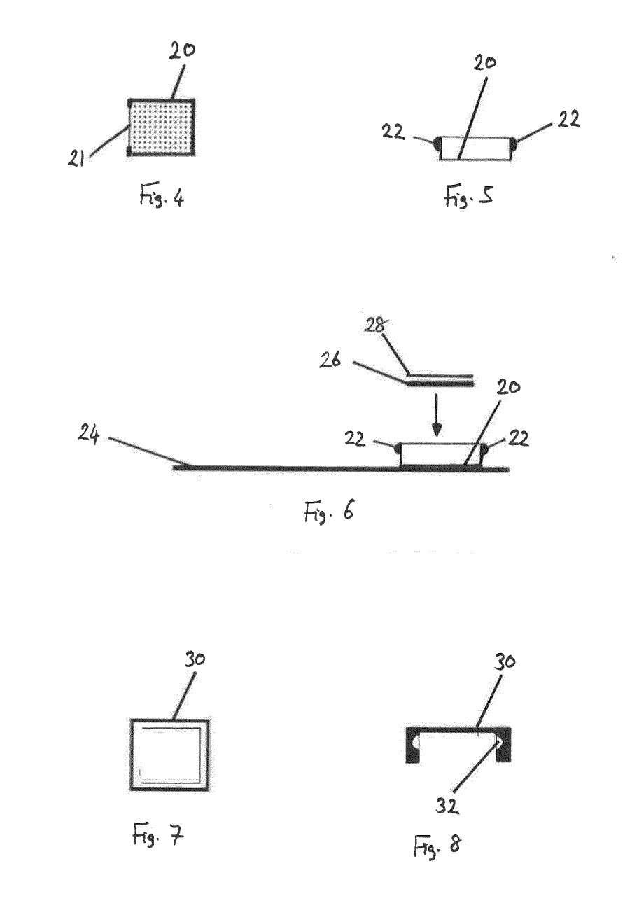

FIG. 6 shows a side/sectional schematic view of a circuit board fitted with the inner casing and ready to receive a fingerprint sensor and protective layer;

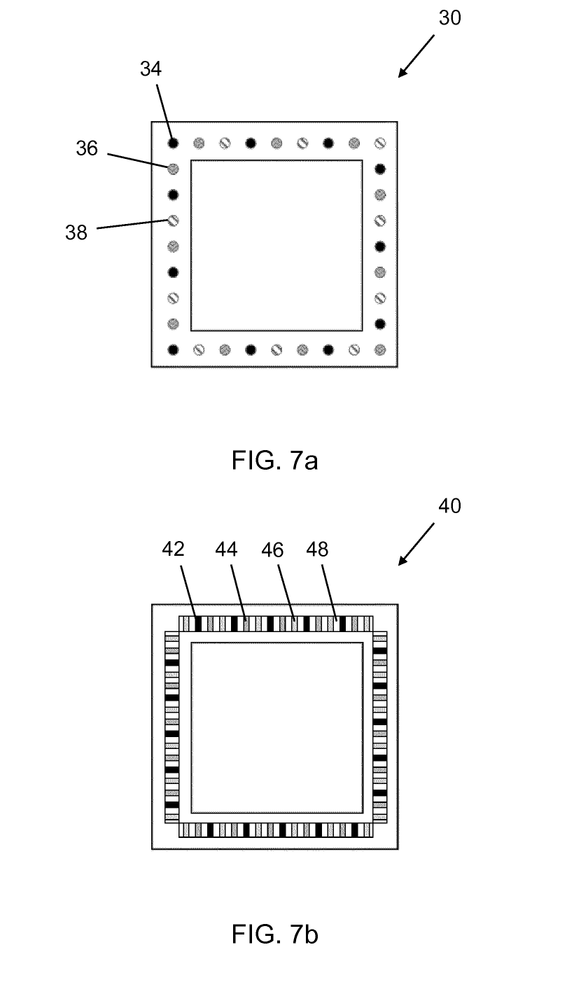

FIG. 7 shows a plan view of an outer bezel for fitting to the inner casing;

FIG. 7a shows a plan view of the outer bezel of FIG. 7 where conductive balls on the bezel are highlighted;

FIG. 7b shows a plan view of an alternative outer bezel where a zebra connector is used in place of the conductive balls;

FIG. 8 shows a side/section view of the outer bezel of FIG. 7;

FIG. 9 shows the circuit board of FIG. 6 and fitting of the outer bezel to the inner casing;

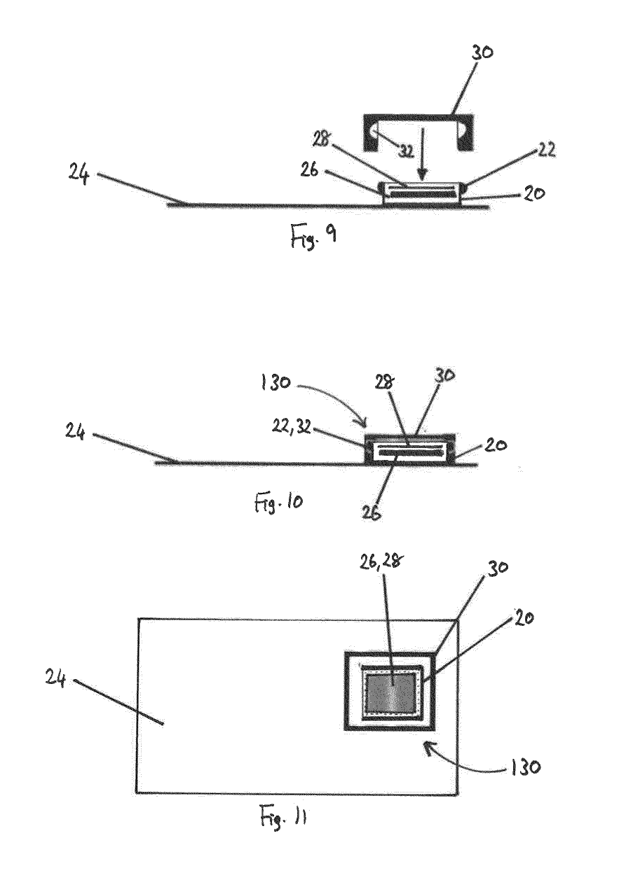

FIG. 10 shows the side/sectional view of the circuit board of FIG. 6 with the outer bezel fitted to the inner casing; and

FIG. 11 shows a schematic plan view of the circuit board of FIG. 10.

By way of example the invention is described in the context of a fingerprint authorised smartcard that includes contactless technology and uses power harvested from the sensor. These features are envisaged to be advantageous features of one application of the proposed fingerprint failure feature, but are not seen as essential features. The smartcard may hence alternatively use a physical contact and/or include a battery providing internal power, for example. The fingerprint sensor assembly 130 described herein can also be implemented with appropriate modifications in any other device or system that uses a fingerprint sensor for fingerprint authorisation.

FIG. 1 shows the architecture of a smartcard 102 that is provided with the fingerprint sensor assembly 130. A powered card reader 104 transmits a signal via an antenna 106. The signal is typically 13.56 MHz for MIFARE® and DESFire® systems, manufactured by NXP Semiconductors, but may be 125 kHz for lower frequency PROX® products, manufactured by HID Global Corp. This signal is received by an antenna 108 of the smartcard 102, comprising a tuned coil and capacitor, and then passed to a communication chip 110. The received signal is rectified by a bridge rectifier 112, and the DC output of the rectifier 112 is provided to processor 114 that controls the messaging from the communication chip 110.

A control signal output from the processor 114 controls a field effect transistor 116 that is connected across the antenna 108. By switching on and off the transistor 116, a signal can be transmitted by the smartcard 102 and decoded by suitable control circuits 118 in the sensor 104. This type of signalling is known as backscatter modulation and is characterised by the fact that the sensor 104 is used to power the return message to itself.

The smartcard further includes a fingerprint authentication engine 120 including a fingerprint processor 128 and a fingerprint sensor assembly 130. This allows for enrolment and authorisation via fingerprint identification. The fingerprint processor 128 and the processor 114 that controls the communication chip 110 together form a control system for the device. The two processors could in fact be implemented as software modules on the same hardware, although separate hardware could also be used. The fingerprint sensor assembly 130 may be used only when power is being harvested from the powered card reader 104, or alternatively the smartcard 102 may be additionally provided with a battery (not shown) allowing power to be provided at any time for the fingerprint sensor assembly 130 and fingerprint processor 128, as well as the processor 114 and other features of the device.

The antenna 108 comprises a tuned circuit including an induction coil and a capacitor, which are tuned to receive an RF signal from the card reader 104. When exposed to the excitation field generated by the sensor 104, a voltage is induced across the antenna 108.

The antenna 108 has first and second end output lines 122, 124, one at each end of the antenna 108. The output lines of the antenna 108 are connected to the fingerprint authentication engine 120 to provide power to the fingerprint authentication engine 120. In this arrangement, a rectifier 126 is provided to rectify the AC voltage received by the antenna 108. The rectified DC voltage is smoothed using a smoothing capacitor and then supplied to the fingerprint authentication engine 120 and other electrical components. Alternatively or additionally a battery may be included as noted above.

The fingerprint sensor assembly 130, which is described in more detail below with reference to FIGS. 4 to 11, may be mounted on a card housing 134 as shown in FIG. 2 or fitted so as to be exposed from a laminated card body 140 as shown in FIG. 3. The card housing 134 or the laminated body 140 encases all of the components of FIG. 1, and is sized similarly to conventional smartcards. The fingerprint authentication engine 120 may be passive, and hence may be powered only by the voltage output from the antenna 108. Alternatively a battery (not shown) may be provided for powering the fingerprint authorisation engine 120. The processor 128 comprises a microprocessor that is chosen to be of very low power and very high speed, so as to be able to perform fingerprint matching in a reasonable time.

When a finger or thumb is presented to the fingerprint sensor assembly 130, the fingerprint authentication engine 120 is arranged first to supply a plurality of voltage signals to an array of emitting electrodes 34 positioned around a scanning area the fingerprint sensor assembly 130. For example, the fingerprint authentication engine 120 may supply a DC signal and one or more sinusoidal signals. The same signal may be sent to multiple different emitting electrodes 34, but each emitting electrode 34 preferably receives only a single signal.

The voltage signals emitted by the emitting electrodes 34 pass through the finger or thumb, and the fingerprint authentication engine 120 is arranged to then detect the resulting signals, after transmission through the finger or thumb, using an array of detecting electrodes 34 positioned around the scanning area the fingerprint sensor assembly 130. Each detecting electrode 34 includes a filter such that it detects only a single one of the voltage signals, although this filter may alternatively be implemented digitally by the processor 128 of the fingerprint authentication engine.

From the detected signals, the fingerprint authentication engine 120 determines the impedance of the finger at each different frequency. These impedance values are compared to expected values and a determination is made as to whether or not the finger is genuine.

If the finger is determined to be genuine, then the fingerprint authentication engine 120 is arranged next to scan a fingerprint of the finger or thumb presented to the fingerprint sensor assembly 130. The fingerprint sensor assembly uses an active capacitance fingerprint sensor, which comprises a scanning area in the form of an array of active capacitance fingerprint sensor electrodes. The fingerprint is scanned by applying a voltage to the finger using an array of driving electrodes 38 arranged around the scanning area and detecting how the voltage is discharged at each of the fingerprint sensor electrodes.

More particularly, pockets of air are trapped by the ridges and valleys of the fingerprint between the surface of the fingerprint sensor and the surface of the finger. These pockets create effective capacitors between the finger and the electrodes. The application of the driving voltage charges these effective capacitors and the electric field between the finger and sensor follows the pattern of the ridges in the dermal skin layer. On the discharge cycle of the voltage signal, the voltage across the dermal layer and sensing element is compared against a reference voltage in order to calculate the capacitance at each electrode. These measured capacitances can be converted into a scanned fingerprint image.

The fingerprint authentication engine 120 is arranged to compare the scanned fingerprint of the finger or thumb to pre-stored fingerprint data using the processor 128. A determination is then made as to whether the scanned fingerprint matches the pre-stored fingerprint data. In a preferred embodiment, the time required for capturing a fingerprint image and authenticating the bearer of the card 102 is less than one second. In various embodiments, the steps of verifying that the finger is genuine and matching the scanned fingerprint against the pre-stored fingerprint data may be performed in parallel.

If a genuine finger is detecting and a fingerprint match is determined, then the processor takes appropriate action depending on its programming. In this example the fingerprint authorisation process is used to authorise the use of the smartcard 104 with the contactless card reader 104. Thus, the communication chip 110 is authorised to transmit a signal to the card reader 104 when a fingerprint match is made. The communication chip 110 transmits the signal by backscatter modulation, in the same manner as the conventional communication chip 110. The card may provide an indication of successful authorisation using a suitable indicator, such as a first LED 136.

An example arrangement for the fingerprint sensor assembly 130 will now be described with reference to FIGS. 4 to 11. It should be noted that for the sake of clarity the figures are shown in schematic form only with exaggerated scale. It will be appreciated that the actual sizes of the various parts, in particular their heights, are much less that shown and that the parts would fit together more closely than indicated in the drawings.

The completed fingerprint sensor assembly 130 mounted on a circuit board, which in this example is a flexible printed circuit board assembly 24, is shown schematically inside/section view in FIG. 10 and in plan view in FIG. 11. The fingerprint sensor assembly includes an inner casing 20 which is shown in plan view in FIG. 4 and in cross-section view in FIG. 5 the inner casing is three sided as can be seen in FIG. 4 and also in FIG. 11. Since one side 21 of the inner casing 20 is left open then it is straightforward to connect circuitry from the circuit board 24 to components held within the inner casing 20 since conductive pathways can pass through the open side 21. The upper edges of the inner casing 20 are in this example provided with protruding lugs 22, which extend around the sides of the inner casing 20. These lugs 22 provide a snap-fit with corresponding recesses 32 on an outer bezel 30 as explained further below.

It should be understood that the lugs 22 and recesses 32 are simply one example of how one might achieve the required interconnections between the inner casing 20 and the outer bezel 30. It would be possible to alternatively have lugs on the outer bezel 30 and recesses on the inner casing 20, or indeed different mechanical arrangements could be used to achieve a suitable snap-fit connection. Couplings known in relation to surface mount technology could be used, or alternatively the connection between the inner casing 20 and the bezel 30 could involve the use of an adhesive or other bonding method.

FIG. 6 shows the inner casing 20 mounted to a flexible printed circuit board assembly 24 and ready to receive a fingerprint sensor 26 and also a protective layer 28. These are inserted through the open top of the inner casing 20 and then connected to circuitry on the flexible circuit board in an appropriate fashion for example by the use of surface mount technology, soldering, or conductive adhesive. The three walls of the inner case 20 are slightly taller than the height of the fingerprint sensor 26 together with the protective layer 28, and this height difference is exaggerated in the Figures. The fingerprint sensor 26 is an active capacitance area fingerprint sensor 26 of any suitable type. The protective layer 28 can be any suitably thin scratch resistant material that is compatible with the fingerprint sensor 26 such as, for example chemically toughened glass. One possible material is alkali-aluminosilicate sheet glass, such as the glass sold under the trade name Gorilla Glass® and manufactured by Corning Inc. of New York, USA. This type of glass is commonly used as a cover glass for touch screens on mobile devices such as smartphones and other similar cover glass products could be used for the protective layer 28. The protective layer 28 is about 400 μm thick, which means that it can be added on top of suitable a fingerprint sensor 26 without adversely affecting the total width of the fingerprint sensor assembly 130, and in particular whilst allowing the smartcard 102 with the fingerprint sensor assembly 130 to meet the thickness restrictions of ISO 7816.

As noted above an outer bezel 30 is mounted to the inner case 20. The outer bezel 30 is shown in plan view in FIG. 7 and in side/sectional view in FIG. 8. It has four side walls forming an open frame with the sides of the frame having an inverted, L-shape section in order that the bezel 30 surrounds the sides of the fingerprint sensor 26 and the protective layer 28 and also extends across and frames the top of the fingerprint sensor 26 and the protective layer 28. This means that the bezel 30 can act to hold the fingerprint sensor 26 and the protective layer 28 in place, including holding the protective layer 28 firmly against the fingerprint sensor 26.

Moreover, the bezel 30 defines an array of electrodes 34, 36, 38, as illustrated in FIG. 7a. The electrodes alternate between an emitting electrode 34, a detecting electrode 36 and a driving electrode 38. As illustrated in FIG. 7a, the electrodes may be formed as a ball grid array on an insulating surface of the bezel 30. However, in an alternative configuration shown in FIG. 7b, electrodes 42, 44, 46 may be formed from electrically conductive members separated by insulating members 48 and surrounded by an insulating material such as an elastomer.

The inner casing 20 may be configured to define conductive paths allowing for an electrical connection between the electrodes 34, 36, 38 via the inner casing 20 to the circuit on the circuit board 24. The inner casing 20 can be connected to the circuit board 24 by soldering or via conductive adhesive, for example, in order to both bond the inner casing 20 to the circuit board 24 as well as electrically connecting the inner casing 20 to the circuit which is formed on the circuit board 24.

The bezel 30 is fitted to the inner casing 20 as shown in FIGS. 9 and 10, in this example this is done with a snap-fit utilising the lugs 22 and corresponding recesses 32. The use of a snap-fit connection, or similar mechanical connection, means that the bezel 30 can be simply pushed into place, whilst the fingerprint sensor 26 and protective layer 28 are already held within the inner casing 20, such that it is simple to both secure the fingerprint sensor 26 and protective layer 28 to the inner casing 20, and to complete the fingerprint sensor assembly 130 by providing a suitable electrically conductive bezel 30, if required, about the fingerprint sensor 26. Moreover, by the use of a two-part bezel assembly made up of the inner casing 20 and the outer bezel 30 then the fingerprint sensor assembly 130 is provided with reinforcement and is well protected from torsional forces that might otherwise be passed to the fingerprint sensor 26 and/or the protective layer 28, which can be relatively fragile in terms of bending and torsion forces. This is particularly helpful in the case of the examples where the fingerprint sensor assembly is used on a smart card 102, especially with a laminated card as shown in FIG. 3. However, the advantages arising from the use of the fingerprint sensor assembly 130 and assembly method described above are also beneficial in other contexts where a fingerprint sensor is used for a biometric league authorised device, for example a control token such as a vehicle keyless entry fob.

Suitable methods for manufacturing various aspects of an electronic card of the type described herein are set forth, for example, in WO2013/160011, U.S. 62/262944, U.S. 62/262943, U.S. 62/312773, U.S. 62/312775 and U.S. 62/312803.

1. A fingerprint authentication device comprising:
an array of first electrodes comprising active capacitance fingerprint sensor electrodes; and
an array of second electrodes positioned adjacent the array of first electrodes such that a finger presented to the array of first electrodes covers at least two of the second electrodes,
wherein the device is configured to supply a driving voltage signal for the fingerprint sensor electrodes via one or more of the second electrodes;
wherein the device is configured to supply one or more property measurement voltage signal(s) via one or more of the second electrodes, and to detect the one or more property measurement voltage signal(s) via one or more of the second electrodes, after transmission through the finger; and
wherein the device is configured to verify the identity of the bearer of the finger based on a fingerprint detected by the fingerprint sensor electrodes, and to validate at least one physical property of the finger based on the detected property measurement voltage signal(s) detected by the array of second electrodes.

2. A device according to claim 1, wherein the second electrodes are arranged to surround the array of first electrodes.

3. A device according to claim 1, wherein the array of second electrodes is configured in the form of a ball grid array or as alternating conductive regions separated by insulating regions in a rubber or elastomer matrix.

4. A device according to claim 1, wherein the one or more property measurement voltage signal(s) comprise at least two different voltage signals.

5. A device according to claim 4, wherein the device is configured to apply a first property measurement voltage signal across a first set of the second electrodes and a second, different voltage signal across a different, second set of the second electrodes.

6. A device according to claim 1, wherein the driving signal for the fingerprint sensor electrodes provides the or one of the property measurement signal(s).

7. A device according to claim 1, wherein the driving voltage signal is different from at least one of the one or more a property measurement signal(s).

8. A device according to claim 1, wherein the one or more property measurement voltage signal(s) comprise a periodically varying voltage signal.

9. A device according to claim 1, wherein the one or more property measurement voltage signal(s) comprise a DC voltage signal.

10. A device according to claim 1, wherein the device is configured to validate the at least one physical property of the finger by comparing either the detected property measurement voltage signal(s) or a value derived therefrom with a stored value.

11. A device according to claim 10, wherein the stored value comprises a threshold value for a valid finger.

12. A device according to claim 1, wherein the at least one physical property of the finger include an electrical property, such as an electrical impedance of the finger.

13. A device according to claim 1, wherein the device is configured to perform an action only when the finger is validated and the identity of a bearer of the finger has been verified.

14. A device according to claim 1, wherein the device is a portable device, such as a smartcard or a control token.

15. A device according to claim 1, wherein the plurality of electrodes are formed on a bezel of an enclosure for holding the fingerprint sensor.

16. A device according to claim 15, wherein the bezel retains a protective layer located on top of a sensing surface of the fingerprint sensor, the protective layer comprising a scratch resistant material.
